(19) United States
(12) Patent Application Publication
(10) Pub. No.: US 2026/0333523 A1
(43) Pub. Date: Oct. 22, 2026

(54) Heating Hose and Method of Manufacture and Use

(71) Applicant: Fraunhofer-Gesellschaft zur Förderung der Angewandten Forschung e.V., München (DE)

(72) Inventors: Rasit Özgüc, Dinslaken (DE); Lukas Kopietz, Duisburg (DE); Michael Joemann, Marl (DE)

(21) Appl. No.: 19/122,056

(22) PCT Filed: Oct. 17, 2023
(86) PCT No.: PCT/EP2023/078876

§ 371 Date: Apr. 17, 2025

(30) Foreign Application Priority Data
Oct. 20, 2022 (DE) 10 2022 127 674.0
Aug. 14, 2023 (DE) 10 2023 121 689.9

(51) Int. Cl. H05B 3/58

(52) U.S. Cl. CPC H05B 3/58

(57) ABSTRACT

A heating hose for electrically heating a pipeline, a container and/or a molded part from the outside is described and illustrated, with at least one electrically conductive heating section in the form of a heating resistor for heating the heating hose at least in sections. In order for electrical heating of pipelines, containers and molded parts to be carried out more cost-effectively, more reliably and at the same time more efficiently, it is provided that the heating hose is configured as a shrink hose with a diameter (D) shrinkable by heating at least in sections for shrinking onto the pipeline, the container and/or the molded part, and that the at least one heating section has at least one thermoplastic material and at least one electrically conductive filler finely distributed in a matrix of the at least one thermoplastic material, and that the at least one electrically conductive heating section is configured for application of an electrical heating voltage or an electrical heating current for shrinking the diameter (D) at least in sections as a result of heating the at least one heating section and/or for inductive heating of the at least one heating section and/or for inductively heating the at least one heating section via an alternating magnetic field and for shrinking the diameter (D) at least in sections as a result of the inductive heating of the at least one heating section.

### CROSS-REFERENCE TO RELATED APPLICATIONS

This application is the United States national phase of International Patent Application No. PCT/EP2023/078876 filed Oct. 17, 2023, and claims priority to German Patent Application Nos. 10 2022 127 674.0 filed Oct. 20, 2022 and 10 2023 121 689.9 filed Aug. 14, 2023, the disclosures of which are hereby incorporated by reference in their entireties.

### BACKGROUND OF THE INVENTION

### Field of the Invention

The invention relates to a heating hose for electrically heating a pipeline, a container and/or a molded part from the outside, with at least one electrically conductive heating section in the form of a heating resistor for heating the heating hose at least in sections. The invention also relates to a method for manufacturing such a heating hose and a method for shrinking such a heating hose.

### Description of Related Art

Heating hoses of this type have been known for some time in various configurations. They are used in particular as trace heating for heating pipelines, containers, molded parts and the like. Due to their tubular shape, the heating hoses can accommodate the pipelines, containers or molded parts at least in sections in order to heat them evenly around their circumference from the outside. For this purpose, a heating wire or several heating wires are provided in the heating hoses, which are electrically conductive and have a resistance which is so high that they form a heating resistor to which a heating voltage or a heating current can be applied. As a result of the heating voltage or heating current applied to a heating hose, the heating wire heats up, which then transfers the resulting heat to the heating hose and the pipe, the container and/or the molded part inside the heating hose.

Heat tracing systems are also known in the form of heating tapes, heating cables and heating cords, which can be wrapped around pipes, containers and molded parts. The heating tapes, heating cables and heating cords also have a heating wire, to the ends of which a heating voltage or a heating current can be applied in order to heat the heating wire in the sense of resistance heating. The heating tapes, heating cables and heating cords then emit heat to the pipes, containers and molded parts around which the heating tapes, heating cables and heating cords have previously been wrapped. Heating tapes, heating cables and heating cords can typically be wound with very tight bending radii. However, care must be taken to ensure that they are not wound too close together and not too far apart in order to, on the one hand, prevent the heating tapes, heating cables and heating cords from overheating and to ensure, on the other hand, that the pipes, containers and molded parts can be heated sufficiently. This is less of a problem with heating hoses, but the heating hoses are usually significantly more expensive than heating tapes, heating cables and heating cords, as the heating hoses have to be configured in advance and adapted to the respective application. The winding of the heating wires of heating hoses cannot be varied afterwards, or only to a very limited extent.

### SUMMARY OF THE INVENTION

Therefore, the present invention is based on the object of configuring and further developing the heating hose and the methods of the type mentioned at the beginning and explained in more detail above in such a way that electrical heating of pipelines, containers and molded parts can be carried out more cost-effectively, more reliably and at the same time more efficiently.

This object is solved in a heating hose as described in that the heating hose is configured as a shrink hose with a diameter that can be shrunk by heating at least in sections for shrinking onto the pipeline, the container and/or the molded part, and that the at least one heating section has at least one thermoplastic and at least one electrically conductive filler finely distributed in a matrix of the at least one thermoplastic, the container and/or the molded part and in that the at least one heating section has at least one thermoplastic material and at least one electrically conductive filler finely distributed in a matrix of the at least one thermoplastic material and in that the at least one electrically conductive heating section for application to an electrical heating voltage or an electrical heating current for shrinking the diameter at least in sections as a result of heating the at least one heating section and/or for inductively heating the at least one heating section via an alternating magnetic field and for shrinking the diameter at least in sections as a result of the inductive heating of the at least one heating section.

By configuring the heating hose as a shrink hose with at least one heating section comprising finely distributed conductive particles, the heating hose can be easily and quickly retrofitted, in particular slipped on, to different pipes, containers or molded parts. At the same time, it is ensured that good heat contact and heat transfer are provided between the heating hose and the object to be heated if the heating hose is selected in the correct size and with the correct shrink factor. After shrinking, the heating hose then lies tightly against the object to be heated. For heating, a conductive filler consisting of small separate particles is finely distributed in the at least one thermoplastic material in the at least one heating section of the heating hose. Consequently, shrinkage of the heating hose cannot damage the heating section.

Shrinking, on the other hand, regularly reduces the electrical resistance of the at least one heating section. If necessary, this may be taken into account in advance when determining the quantity and type of conductive particles in the at least one heating section. On the one hand, reliable conduction of the electric current of the at least one heating section should hereby be ensured. On the other hand, the conduction of the electric current should be opposed by a sufficiently large resistance so that a sufficiently large heat flow is generated in the at least one heating section as soon as the heating voltage or the heating current is applied to the heating hose.

On the one hand, heating the heating hose by applying a heating voltage or a heating current to the heating hose is intended to heat up the heating hose and heat the object enclosed by the heating hose. On the other hand, the initial application of the heating voltage or the heating current can cause the heating hose to heat up, which causes the heating hose to shrink onto the pipe, the container, the molded part or similar. For this purpose, a minimum temperature must be exceeded, which is essentially determined by the thermoplastic material or the thermoplastic materials used. It is not necessary to shrink the heating hose using a hot air blower, so that a work step can be saved or at least simplified. Nevertheless, it may be possible to shrink the heating hose using a hot air blower. In principle, direct current or alternating current can be applied to the heating hose for trace heating and shrinking.

The said problem is further solved as described herein by a method of manufacturing a heating hose as described herein,
in which a raw hose with at least one heating section comprising at least one thermoplastic and at least one conductive filler finely distributed in the matrix of the thermoplastic is extruded,
in which the diameter of the extruded tube is widened, preferably by stretching, and
in which, preferably, the at least one heating section is connected to two electrical contacts for applying an electrical voltage or an electrical current.

The extrusion of extrudates comprising at least one thermoplastic material on the one hand and at least one conductive filler on the other is already known from other applications, although in this case, departing from the known methods, no raw hose is extruded. Here too, however, it is important that the filler and thermoplastic are mixed as homogeneously as possible in order to produce a satisfactory heating section of the heating hose. The proportions and ratios of thermoplastic material and electrically conductive filler to be used and how homogeneous the distribution of the electrically conductive filler should be depends heavily on which thermoplastic material and which type of electrically conductive filler is used. Further, the particle size as well as their porosity and surface properties can be of considerable importance. Nevertheless, the skilled person will be able to provide a suitable extrudate or further optimize it with a manageable number of trials.

Once the raw hose has been extruded, it is widened, which can be done using a stretching process, whereby the raw hose can be stretched in a radial and/or circumferential direction in particular. The raw hose can be heated and stretched to increase its diameter. In this form, the stretched raw hose can be frozen, so to speak, by cooling. In order to be able to apply a heating voltage or a heating current to the heating hose, the at least one heating section can be provided with at least two electrical contacts, via which the at least one heating section can be connected to a voltage supply or power supply. For example, cable connection clamps, pipe clamps and band clamps can be used here. Instead of clamps, however, only punctual, non-circumferential contacts can be used, which may also be known from other applications.

If the at least one heating section of the heating hose is heated inductively via an alternating magnetic field, corresponding contacts are generally optional. In principle, the heating hose can be heated inductively both to shrink the heating hose and to heat a pipe, a container and/or a molded part. It is therefore possible, for example, to shrink the heating hose inductively and to heat the pipe, the container and/or the molded part by applying an electrical voltage or an electrical current to contacts on the heating hose.

Furthermore, the term clamp is to be understood very broadly here and should also include other elements, even if these are not usually referred to as clamps. The clamps should be provided on or in a corresponding section of the heating hose, where they make electrically conductive contact with at least one heating section or electrically conductively connect several heating sections to one another. In particular, circumferential bands, O-rings and the like can also be used here. The clamps do not necessarily have to be made of a metallic material. The clamps can also be made of a plastic material that absorbs an electrically conductive filler in a finely distributed manner, similar to the actual heating hose itself.

Similar to the actual heating hose itself, the clamp can also be configured as a shrink sleeve for shrinking onto the actual heating hose.

Moreover, the aforementioned problem is solved by a method for shrinking a heating hose and/or manufactured as described herein,
in which the heating hose is slipped onto a pipe, a container and/or a molded part,
in which at least two contacts of at least one heating section of the wound-up heating hose are connected to a heating voltage or a heating current and the heating voltage or the heating current heats the at least one heating section in the form of a heating resistor and/or the at least one heating section is heated inductively via an alternating magnetic field, and
in which the heating hose is shrunk onto the pipeline, the container and/or the molded part as a result of the heating of the at least one heating section while reducing the diameter.

In its widened form, the heating hose can simply be pulled onto the pipe, the container and/or the molded part due to the increased diameter. The corresponding object is then at least partially located in the heating hose, whereby there is preferably a certain amount of play between the corresponding object and the heating hose. The object is then loosely held in the heating hose. The heating hose is then still not tightly seated on the object. To achieve this, at least in sections, the heating hose can be connected with the at least two contacts of the heating section to a heating voltage or a heating current that heats the heating section, as the heating section is configured as a heating resistor. The (specific) resistance of the heating section is so high that the electric current flows through the heating section in accordance with the heating voltage or the heating current, generating a high level of heat. Ultimately, a high level of electrical energy is dissipated into the heating section and released in the form of heat. However, the heat also leads to self-heating of the heating hose. If a minimum temperature is exceeded, the heating hose attempts to contract back to its original size with a smaller diameter, similar to a shape memory material. This is also referred to as shrinking. As a result of shrinking, the heating hose fits tightly against the pipe, the container and/or the molded part, which is also referred to as shrinking-on.

The heating hose can also be shrunk inductively by exposing the at least one heating section to an alternating magnetic field. An induction coil can be used for this purpose. An induction coil through which an alternating current flows generates a magnetic field that changes direction and is characterized by a magnetic flux. If a heating section is introduced into this magnetic field, a voltage is induced in it. The induced voltage generates a current flow (Lenz's rule). In the heating section, eddy current losses occur at the conductive particles, which are converted into heat at the conductive particles. In principle, it would also be conceivable to shrink the heating hose regularly by heating it with the aid of a hot air blower. The heat is then transferred directly to the heating hose via warm air.

This ensures very good and close contact between the heating hose on the one hand and the pipe, the container and/or the molded part on the other, and therefore good heat transfer from the heating hose to the object surrounded by the heating hose. This makes it possible to control the temperature of the corresponding object very precisely, at least in the corresponding section, without risking local overheating. At the same time, this is also very efficient, as heat loss through air gaps between the object and the heating hose can be avoided. Finally, the risk of the heating hose being damaged and rendered unusable by a break in the heating wire installed in it is also eliminated. In the case of the heating hose according to the invention, on the other hand, partial damage to the heating section can be tolerated if it is sufficiently wide. In this case, an electrically conductive connection still remains between the electrical contacts of the heating hose.

In a first particularly preferred embodiment of the heating hose, the at least one electrically conductive filler is carbon-based and is formed in particular from carbon black and/or graphite. The electrically conductive filler can also be formed by metallic particles, whereby iron and/or copper particles are particularly suitable. Alternatively or additionally, the at least one thermoplastic material can be a polyolefin, in particular polyethylene (PE) or polypropylene (PP), polyamide (PA), fluoroethylene propylene (FEP), polyethylene terephthalate (PET), polyvinylidene fluoride (PVDF), Viton, polyvinyl chloride (PVC) and/or polytetrafluoroethylene (PTFE). The physical and, in particular, the electrical properties of the heating hose are determined to a not inconsiderable extent by the choice of materials. The person skilled in the art can therefore influence the desired physical properties of the heating hose by selecting suitable materials. The materials mentioned are all available at relatively low, albeit different, costs.

The heating hose can be made at least in sections from a raw hose formed by extrusion. This is a very reliable and cost-effective method of forming a heating hose. Alternatively or additionally, the heating hose can be produced at least in sections by widening the diameter of the raw hose produced by extrusion or another method. The expansion can be carried out in a similar way to blown film production, for example, by blowing pressurized blown air into the raw hose. The raw hose is then widened in a radial direction. The heating hose in the widened form is used for drawing onto the pipeline, the container and/or the molded part and is therefore widened to a suitable extent. As an alternative to extrusion, the heating hose can also be formed from a film which has at least one heating section and which is joined together, in particular welded, at the edges. A raw hose can also be formed in this way, which can then be further processed in the manner described.

In order to give the heating hose, in particular the raw hose, a high degree of shape memory for subsequent shrinking, it may be useful if the molecules of the at least one thermoplastic material are at least partially cross-linked with each other. If this is done before the diameter is widened, this can lead to a more pronounced shape memory. One way of providing the cross-linking in a practical, simple, reliable and reproducible manner is to irradiate the at least one thermoplastic with electrons. This process is generally known from plastic film production, for example.

The diameter of a tube can be widened independently of this by stretching. The tube is stretched in a radial direction, beyond the elastic yield point, so that the molecules are aligned in the stretching direction. As a result of the alignment, the molecules are closer together and therefore greater attractive forces act between the molecules. Stretching can be carried out at an elevated temperature, followed by cooling in order to essentially maintain the alignment of the molecules. If the thermoplastic is then heated, the molecules align themselves more randomly again, i.e. more isotropically, whereby the heating hose contracts, i.e. shrinks.

For some applications, it can be disadvantageous if the heating hose is essentially electrically conductive. In such cases, it may therefore be advisable for the heating hose to be formed with several layers, which can preferably be aligned at least substantially concentrically to one another. The layers are then either concentric or only essentially concentric to each other. A mathematically exact concentric arrangement is therefore not essential. If the pipe, the container and/or the molded part is made of an electrically conductive material, it is possible to avoid energizing the corresponding object when heating it with the heating hose if an inner layer is configured to be electrically insulating. The electrically conductive heating section of the heating hose then does not come into direct contact with the electrically conductive pipe, the electrically conductive container and/or the electrically conductive molded part.

Alternatively or additionally, an outer layer can also be configured to be electrically insulating from the at least one heating section. In such a case, the risk of electric shock is reduced, as is the risk of a short circuit. However, it is also impossible for the current from the heating section to be transferred to another object in contact with the heating hose.

If the heating hose has contacts assigned to its two opposite ends for applying the heating voltage or heating current, the heating hose can be subjected to a heating voltage or heating current without the need for complex cable routing. In addition, a uniform current density and thus uniform heating of the heating hose can be achieved. In such a case, it may also be appropriate for these reasons if the at least one heating section is provided circumferentially and/or over at least substantially the entire longitudinal extent of the heating hose. The at least one heating section can therefore be provided over the entire longitudinal extent of the heating hose or only over at least substantially the entire longitudinal extent of the heating hose. It can therefore be functionally harmless if the at least one heating section does not extend over the entire longitudinal extent of the heating hose.

Alternatively or additionally, the heating hose can also have at least two heating sections that are electrically separated from each other on the circumferential side over at least approximately the entire longitudinal extent. The heating sections can therefore be electrically separated from each other only approximately over the entire longitudinal extent on the circumferential side or preferably be electrically separated from each other over the entire longitudinal extent on the circumferential side. Here and in the following, circumferential can generally be understood as along the circumference or in the circumferential direction. In this way, it can be achieved that the current in the at least two separate heating sections flows in different directions, in particular in opposite directions, for example in the longitudinal direction or in the circumferential direction. This ultimately allows the heating hose to be connected to the heating voltage or the heating current from one side via corresponding contacts on the at least two separate heating sections. Depending on the length of the heating hose, this can save a considerable length of cable for connecting the heating hose. However, this is not necessary. At least two heating sections extending in the longitudinal direction can also be provided, which are nevertheless provided at opposite longitudinal ends with contacts for applying a heating voltage or a heating current. Alternatively or additionally, a contact can be assigned to each heating section.

At the opposite end with respect to the electrical contacts and the connection of the heating voltage or the heating current, the at least two heating sections can be electrically connected to each other in order to close the corresponding circuit. For the sake of simplicity, the at least two heating sections can be connected to each other via an electrically conductive clamp, which is provided to contact the heating sections. The clamp should then be electrically conductive at least to such an extent that the at least two heating sections are electrically connected to each other via the clamp.

As mentioned above, the term clamp can be understood very broadly in the present case. If necessary, the term clamp also includes elements that are not usually referred to as clamps. The clamps should be provided on or in a corresponding section of the heating hose and make electrically conductive contact with at least one heating section or electrically conductively connect several heating sections to one another. In particular, circumferential bands, O-rings and the like can also be used here. The clamps do not necessarily have to be made of a metallic material. The clamps can also be made of a plastic material that absorbs an electrically conductive filler in a finely distributed manner, similar to the actual heating hose itself. Similar to the actual heating hose itself, the clamp can also be configured as a shrink sleeve for shrinking onto the actual heating hose.

In the case of at least two heating sections, at least two contacts for applying the heating voltage or heating current can therefore be assigned to one longitudinal end of the heating hose. It may then be sufficient to supply the heating hose with the heating voltage or heating current from one side. For the sake of simplicity, one contact can be assigned to each heating section in order to save unnecessary contacts and cables.

The at least two heating sections can also be connected to each other via at least two connecting sections, whereby the connecting sections can extend at least essentially over the entire longitudinal extent of the heating hose. The connecting sections can have an electrical conductivity which means that the connecting sections can at least in principle be regarded as electrically connected in parallel with each other. If the connecting sections have a significantly, in particular by very much, lower resistance than the heating sections, the heating hose can be viewed in an equivalent circuit diagram as a parallel connection of the heating resistances of the heating sections. Consequently, the heating resistance of the heating sections can decrease with increasing length of the heating hose. The power in relation to the length of the heating hose then increases as the length of the heating hose increases. If, on the other hand, the heating resistances of the heating sections are connected in series, the heating resistance can increase with the length of the heating hose and the power related to the length of the heating hose decreases, so that in the case of such a series connection, the heating resistances of the heating sections should be set specifically in order to be able to provide the desired length-specific power. The parallel connection of the heating resistors is more practical with regard to the manufacture and use of the heating hoses. The power related to the length of the heating hose is then not limited for a given voltage of the power source.

For this purpose, the connecting sections, in contrast to the heating sections, have such a low resistance that no significant or a very low, in particular negligible, heat flow is generated in the connecting sections compared to the heating sections. The specific resistances of the at least two heating sections can therefore each be at least twice as high, preferably at least five times as high, in particular at least ten times as high, as the specific resistances of the at least two connecting sections.

Alternatively or additionally, the at least two connecting sections can be coextruded with the heating sections. The conductivity of the connecting sections can then be specifically adjusted in this area by introducing conductive fillers into the matrix of a thermoplastic material. If necessary, but not necessarily, this can be the same thermoplastic material and/or filler as in the heating sections. Alternatively or additionally, at least one metallic wire, a metallic strip and/or a metallic wire mesh can also be provided in the connecting sections. The wire, the metallic strip and/or the wire mesh may be provided in the thermoplastic material of the connecting section or may be used up on it, for example after coextrusion of the heating hose and/or raw hose. Alternatively or additionally, the increased conductivity in the area of the connecting sections can also be achieved by applying a conductive coating, in particular in the form of a varnish, to the area of the connecting sections.

In order to enable heating of the pipe, the container and/or the shaped part that varies over the circumference of the heating hose, the at least one heating section can be provided on the circumferential side over a length of less than 70%, preferably less than 50%, in particular less than 30% of the circumference. The remaining part of the circumference of the heating hose can then be insulating or partially formed by at least one further heating section.

In a first particularly preferred method for manufacturing a heating hose, the raw hose can be coextruded from at least two different extrudates, at least one extrudate having no electrically conductive filler. Along with the at least one extrudate which has at least essentially no electrically conductive filler, an electrically non-conductive non-heating section extending in the longitudinal direction and/or an inner and/or outer circumferential, electrically non-conductive non-heating section can then be coextruded.

If a section formed with the non-conductive extrudate extends in the longitudinal direction of the heating hose, corresponding areas can be specifically excluded from heating. If at least two such sections of the heating hose extending in the longitudinal direction are provided, these can separate two separate, electrically conductive heating sections from each other on the circumferential side, so that the current in these heating sections can flow in different, in particular opposite, directions.

By coextruding an inner, circumferential non-heating section, for example in the form of a non-heating layer, electrical insulation can be provided between the heating hose and the object enclosed by the heating hose for heating. If, additionally or alternatively, an outer circumferential non-heating section is provided, for example in the form of a non-heating layer, there is reliable electrical insulation of the heating hose against electrically conductive objects that may be in contact with the outside of the heating hose. This is preferable for safety reasons and/or to avoid short circuits, for example.

Alternatively or additionally, two heating sections extending in the longitudinal direction and at least substantially separated from one another on the circumferential side can be coextruded from at least one extrudate with at least one electrically conductive filler. The current can thus flow in one direction in one heating section and in the other direction in the other heating section in order to provide varying current densities and/or to enable the heating hose to be connected to the heating voltage or the heating current on only one side.

In order for the at least two heating sections being electrically connectable to each other, a circumferential clamp or another, in particular circumferential, connection can be provided, which is electrically conductive at least in sections and contacts the heating sections there, at least in the connection area between two circumferentially neighboring heating sections.

A previously manufactured raw tube, in particular by extrusion, can be irradiated with electrons before the raw tube is widened so that molecules of the thermoplastic polymer cross-link with each other. In this way, the raw tube can be given a certain shape memory for subsequent shrinking. Alternatively, the raw tube is heated before expansion and cooled after expansion. Even then, the raw hose can be given a certain shape memory. When reheated, the heating hose then contracts and can be shrunk onto an object. This is known in principle from the manufacturing of electrically insulating shrink tubing.

### BRIEF DESCRIPTION OF THE DRAWINGS

In the following, the invention is explained in more detail with reference to a drawing showing only embodiments. The drawing shows

FIG. 1A-B a method according to the invention for manufacturing a heating hose according to the invention and a method according to the invention for shrinking the heating hose, respectively in a schematic representation,

FIG. 2 a second heating hose according to the invention in a perspective side view,

FIG. 3 a third heating hose according to the invention in a perspective side view,

FIG. 4 a fourth heating hose according to the invention in a perspective side view,

FIG. 5 a fifth heating hose according to the invention in a perspective side view, and

FIG. 6A-C a sixth heating hose according to the invention in a perspective side view, an equivalent circuit and a perspective sectional view.

### DESCRIPTION OF THE INVENTION

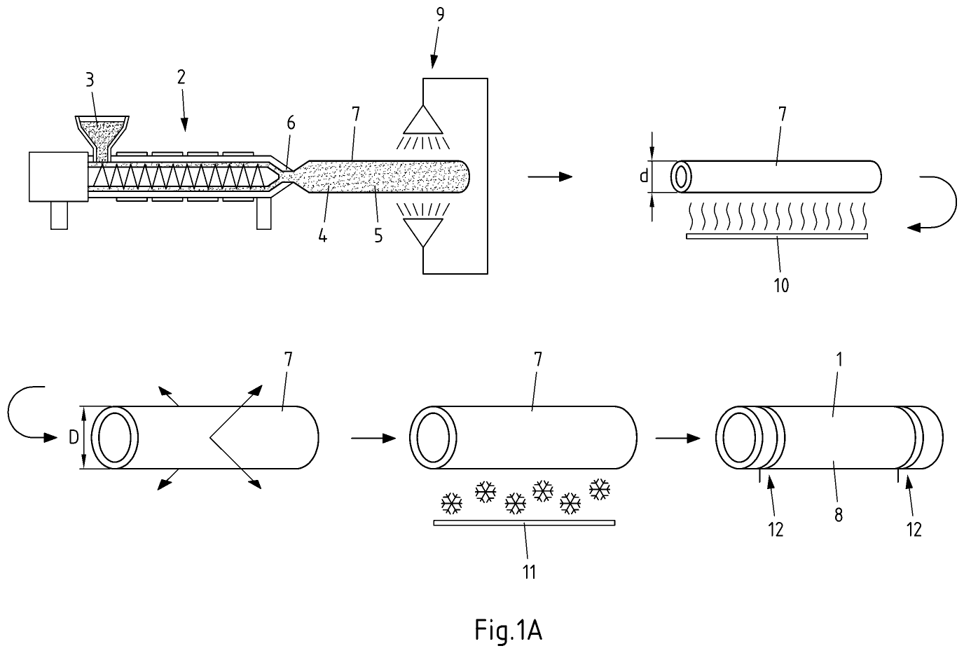

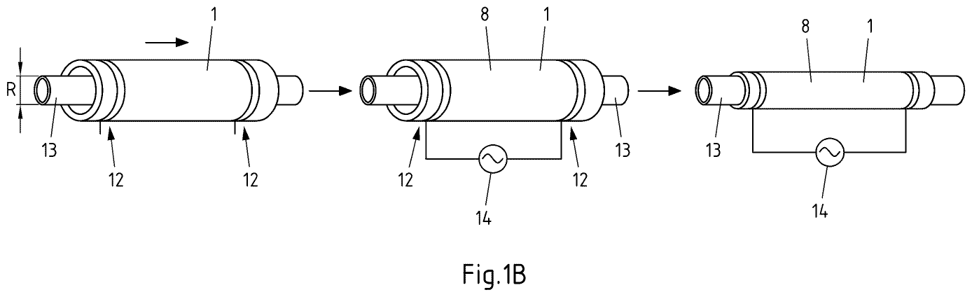

FIG. 1A shows a process for manufacturing a heating hose 1. In this method, a raw hose 7 is first extruded through a corresponding nozzle 6 by means of an extruder 2 and an extrudate 3 comprising a thermoplastic material 4 and a particulate filler 5 of electrically conductive, fine particles. The electrically conductive particles of the filler 5 are either finely distributed in the thermoplastic material 4 in the extruder 2 or a raw material made of a thermoplastic material 4 in which the filler 5 is already finely distributed is fed to the extruder 2. The raw tube 7 extruded in this way then has a matrix of the thermoplastic material 4 as a continuous phase, in which the particulate filler 5 of electrically conductive particles, at least in sections, is finely distributed as a disperse phase. The raw hose 7 is therefore electrically conductive, whereby the electrical conductivity of the raw hose 7 is distributed very homogeneously in the raw hose 7 or the corresponding heating section 8.

After extrusion, the raw tube 7 is moved through or placed in an irradiation device 9 in which the raw tube 7 is irradiated with electrons. The irradiation of the raw tube 7 causes molecules of the thermoplastic material 4 to crosslink with each other. Corresponding irradiation devices 9 are generally known from other applications. The finished cross-linked raw tube 7 is cut to size in the illustrated and in this respect preferred method and then heated by means of an external heat source 10. The heated raw tube 7 is then stretched in a radial direction in accordance with the arrows shown above the elastic yield point, i.e. stretched. This increases the diameter d of the extruded raw hose 7 to the diameter D of the correspondingly widened heating hose 1. The heating hose 1 is then cooled in the widened state by means of a cooling device 11 and provided with electrical contacts 12. The ratio of the diameters d and D may represent the shrinkage factor of the heating hose 1, which may or may not correspond to the diameter ratio. Whether this is the case is determined by whether or not the heating hose 1, which is not mounted on an object, could theoretically shrink to the diameter d of the raw hose 7.

However, the heating hose 1 does not necessarily have to be fitted with electrical contacts 12. This can be useful for pre-assembly and easier subsequent installation of the heating hose 1. The contacts 12 should then preferably be captive on the heating hose 1. In other cases, however, it may also be desirable to attach the contacts 12 only after assembly or shortly before assembly of the heating hose 1. In such a case, the final length of the heating hose 1 acting as a heating resistor can be determined on site and thus very precisely. For example, the heating hose 1 is first shortened on site to the exact length required and then provided with contacts 12 at the opposite ends or with a contact 12 at one end only.

The completed heating hose 1 can then be transported to its place of use, where the heating hose 1 is pushed onto a pipe 13 in the preferred method shown in FIG. 1B. The pipe 13 has a pipe diameter R that is larger than the diameter d of the pipe hose 7 but at the same time significantly smaller than the diameter D of the heating hose 1 in the widened state. In the next step, the heating hose 1 is connected via the electrical contacts 12 to a voltage or current source 14, which is used to apply a heating voltage or a heating current to the heating hose 1. In principle, both a direct voltage and an alternating voltage can be applied. The heating hose 1 is essentially formed by a conductive heating section 8, the conductivity of which is caused by the conductive particles of the filler 5 that are finely distributed in the thermoplastic material 4. However, the resistance of the heating section 8 is so high that heat is generated as a result of the heating voltage or heating current applied to the heating hose 1, which is so high that the heating hose 1 is heated to such a high temperature that the heating hose 1 contracts automatically, i.e. shrinks, as is known from electrically non-conductive shrink sleeves. The heating hose 1 shrinks to such an extent that it is shrunk onto the pipe 13 firmly and in full-surface contact.

The heating hose 1 shrunk onto the pipe 13 in this way can in future be provided with a heating voltage or a heating current as desired, although this does not lead to further shrinkage of the heating hose 1, but only to heat generation and heating of the pipe 13. The pipe 13 can therefore be heated from the outside by applying a suitable voltage or a suitable current to the heating hose 1 in the sense of trace heating.

If required, the heating hose 1 can also be shrunk without applying an electrical voltage or an electrical current to the heating section 8 via the contacts 12 of the heating hose 1. Instead, the heating hose 1 can be shrunk inductively without contact by applying an alternating magnetic field. The alternating magnetic field induces a voltage in the heating section 8, which leads to eddy current losses that cause the heating hose 1 to heat up. If a sufficient temperature is reached, the heating hose 1 shrinks analogously to the application of a voltage or current to the contacts 12 of the heating hose 1. A sufficient temperature can also be reached by applying hot air from a hot air blower to the heating hose 1.

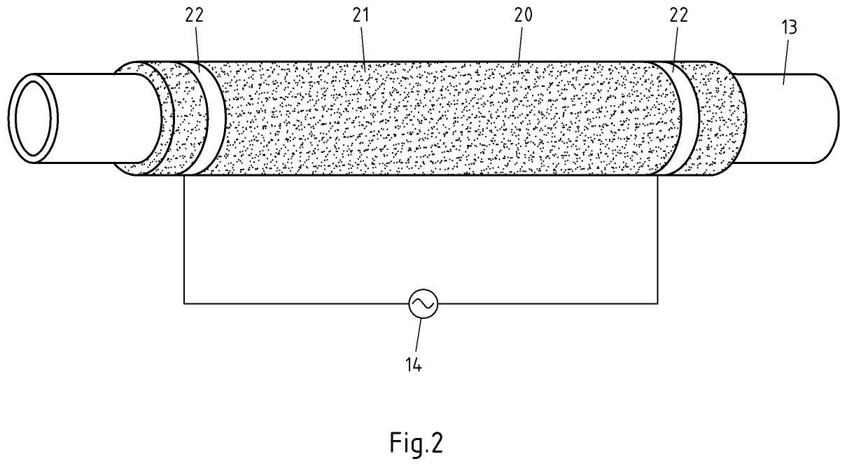

In FIG. 2, a heating hose 20 is shown in a perspective view, whereby the heating hose 20 is pulled onto a pipe 13 and shrunk on. The heating hose 20 is formed from a continuous layer of a mixture of a thermoplastic material 4 and an electrically conductive, particulate filler 5 finely distributed therein. The heating hose 20 therefore forms a heating section 21 that is continuous both in the longitudinal direction and in the circumferential direction. A heating current can therefore flow through the entire heating section 21 and thus the entire heating hose 20 from one side to the other when the heating hose 20 is connected to a heating voltage or a heating current. For this purpose, the opposite longitudinal ends of the heating section 21 of the illustrated and in this respect preferred heating hose 20 are provided with circumferential clamps 22, which are connected to a voltage supply or power supply for applying the heating voltage or heating current. The heating current therefore flows through the heating section 21 and generates heat, which is emitted to the pipe 13 enclosed in sections by the heating hose 20. In this way, a medium flowing through the pipe 13 can be heated.

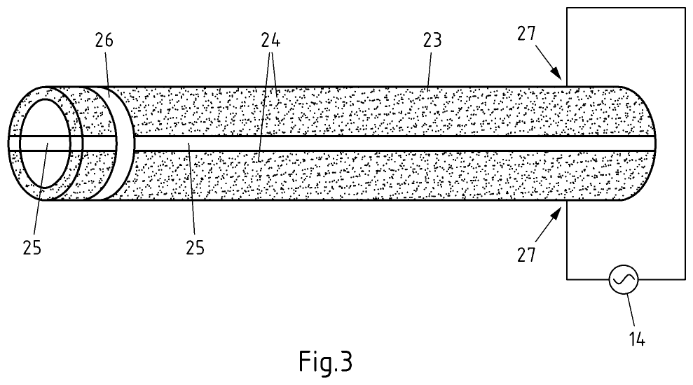

FIG. 3 shows a further heating hose 23 in a perspective view, whereby an additional pipe has been omitted for the sake of clarity. The heating hose 23 is made from a coextruded raw hose. Four different areas are produced around the circumference by co-extrusion. Two of these areas are heating sections 24, which have a thermoplastic material 4 and an electrically conductive filler 5 finely distributed therein. The heating sections 24 are electrically conductive and can serve as heating resistors. Two further areas are electrically non-conductive non-heating sections 25. These non-heating sections 25 are therefore not suitable as heating resistors. Although it cannot be ruled out that the non-heating sections 25 have an electrically conductive filler 5, the proportion of filler 5 is so low and its resistance so high that the non-heating sections 25 conduct virtually no electrical current.

The heating sections 24 and the non-heating sections 25 are provided alternately to each other on the circumferential side, so that the heating sections 24 are separated on the circumferential side by the non-heating sections 25. In the heating hose shown and preferred in this respect, the heating sections 24 and the non-heating sections 25 extend with at least substantially constant width over at least substantially the entire length of the heating hose 23. A clip 26 is provided at one longitudinal end of the heating hose 23, which is electrically conductive and on the one hand contacts the heating sections 24 and on the other hand connects them to each other in an electrically conductive manner. At the end of the heating hose 23 opposite the clamp 26, an electrical contact 27 is provided on each heating section 24, which can be connected to the one voltage or current source 14 to apply the heating voltage or heating current. In this case, the heating current flows through a heating section 24 to the clamp 26 and through the clamp 26 into the other heating section 24 in order to flow back to the voltage source 14 in this heating section 24. This generates heat that can be transferred to the object held in the heating hose 23, at least in sections.

For example, a band or O-ring made of a plastic that is conductive at least in sections on the circumference could also be used as a clamp. The plastic can have an electrically conductive, finely distributed filler at least in the corresponding areas. If necessary, the tape can have the same plastic and/or the same filler as the rest of the heating hose 1. Like the actual heating hose, the circumferential tape could also be configured as a shrink sleeve and shrunk onto the pipe 13 or another object to be heated together with the actual heating hose 1. It is also conceivable that an end section of the heating hose 1 could be cut off, rotated by 90°, for example, and pulled over the corresponding end of the heating hose 1 in order to form a clamp for electrically connecting the heating sections 24 at this end of the heating hose. The term clamp can therefore be understood very broadly if necessary and is used here as a kind of general umbrella term for the sake of better comprehensibility, also to avoid unnecessary repetitions.

In this context, it is understood that another means can also be provided instead of the clamp 26 in order to connect the heating sections 24 to one another in sections. These means can also be integrated into the hose material, for example by providing a sufficient amount of electrically conductive filler 5 similar to the heating sections 24. It is also conceivable that more than two heating sections 24 and correspondingly several non-heating sections 25 are provided in between.

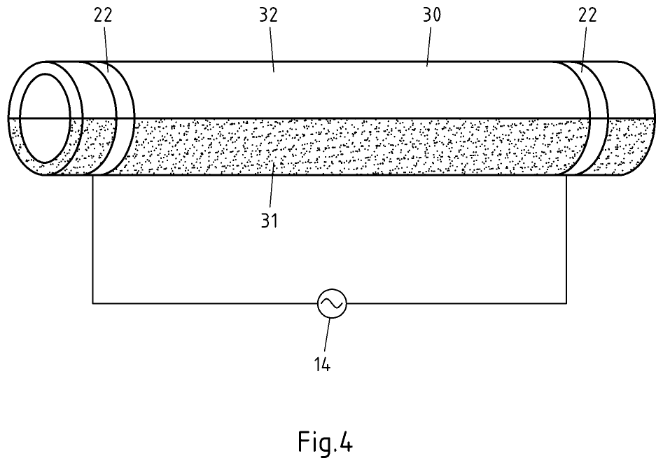

A heating hose 30 is shown in FIG. 4, which has a heating section 31 and a non-heating section 32 around the circumference of the heating hose 30. The heating section 31 and the non-heating section 32 are configured in principle like the heating sections 24 and the non-heating sections 25 of the heating hose 23 according to FIG. 3. The heating section 31 and the non-heating section 32 extend over the entire longitudinal extent of the heating hose 30 and each form part of the circumference of the heating hose 30. The electrical contacts 22 are attached to the opposite ends of the heating section 31 in order to be able to apply a heating voltage or a heating current to the heating hose 30. Since the heating section 31 in the illustrated and in this respect preferred heating hose 30 is only provided over about half of the circumference, a pipeline can be heated specifically from one side by means of the heating hose 30, but not also from the other side if this should be desirable.

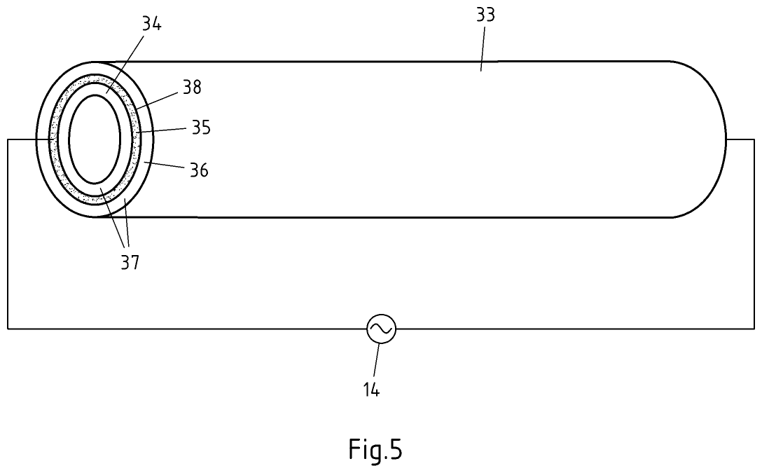

FIG. 5 shows a heating hose 33 which is formed from three layers 34, 35, 36 arranged concentrically to one another, which are all firmly connected to one another. The three layers 34, 35, 36 are preferably formed together by coextrusion. The inner and outer layers 34,36 are formed over the entire circumference as non-heating sections 37, which can also be referred to as a non-heating layer. The inner layer 34 and the outer layer 36 have so little electrically conductive filler 5 that these two layers 34, 36 do not conduct the electric current applied to the middle layer 35 of the heating tube 33, or conduct it as good as not. The inner layer 34 and the outer layer 36 thus act as electrical insulation with respect to the middle layer 35, which in the illustrated and in this respect preferred heating hose 33 is formed over its entire circumference as a heating section 38, which can also be referred to as a heating layer.

However, this is not absolutely necessary. For example, several heating sections 38 and one or more non-heating sections 37 could be provided in the middle layer 35. It is also conceivable that several middle layers 35 exist, which are configured differently from one another with regard to the heating section 38 or the heating sections 38. Alternatively or additionally, the inner layer 34 (non-heating layer) or the outer layer 36 (non-heating layer) could be omitted. In the heating hose 33 shown, only the inner layer 35 (heating layer) conducts the electric current. This means that heat is only generated in the inner layer 35 by dissipating electrical energy. However, the heat can still be used to heat a pipe 13, for example, without energizing it. The heat is also sufficient to shrink the heating hose onto the pipe 13.

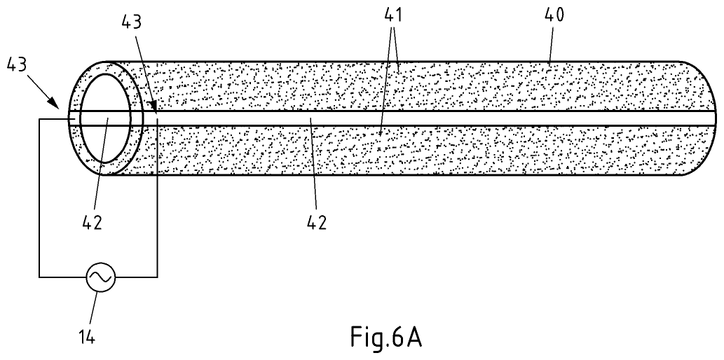

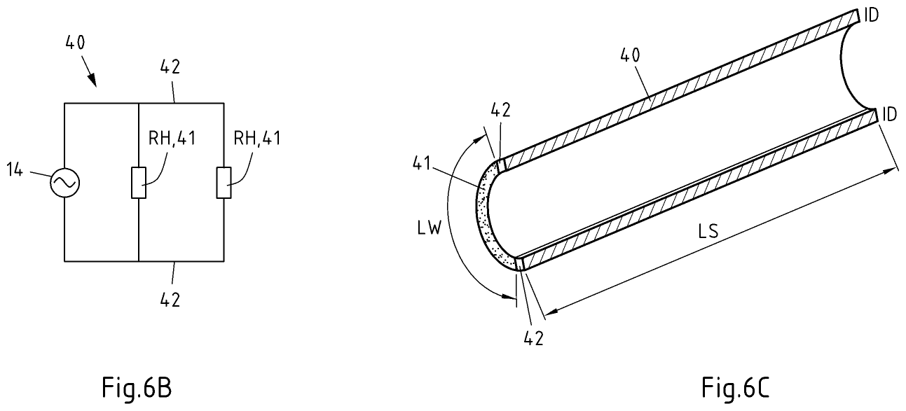

FIG. 6A shows a further heating hose 40 in a perspective view. The heating hose 40 is made, for example, from a coextruded raw hose. The co-extrusion process produces four different areas around the circumference. Two of these areas are heating sections 41, which have a thermoplastic material 4 and an electrically conductive filler 5 finely distributed therein. The heating sections 41 are electrically conductive and can serve as heating resistors. Two further areas are connecting sections 42 with a considerably lower electrical resistance compared to the heating resistances of the heating sections 41.

The connecting sections 42 therefore do not form a heating resistor of the heating hose 40. The connecting sections 42 are each provided with a contact 43 for connection to a heating voltage or a heating current via the voltage or current source 14. In the illustrated and thus preferred heating hose 40, the contacts 43 are provided at the same longitudinal end of the heating hose 40 for the sake of simplicity. Due to the low electrical resistance of the connecting sections 42 compared to the heating sections 41, the connecting sections 42, unlike the heating sections 41, do not act as heating resistors, but connect the heating sections in parallel to each other to the voltage or current source 14.

The heating sections 41 and the connecting sections 42 are provided alternatingly to one another on the circumferential side, so that the heating sections 41 are separated on the circumferential side by the connecting sections 42. In the heating hose 40 shown and preferred in this respect, the heating sections 41 and the connecting sections 42 extend with at least substantially constant width over at least substantially the entire length of the heating hose 40.

In this case, the heating current flows in the longitudinal direction of the heating hose 40 through the connecting sections 42 and in the circumferential direction through the heating sections 41. The heating hose 40 connected to the voltage or current source 14 via the contacts 43 can be represented as an equivalent circuit diagram according to FIG. 6B, in which the heating resistors RH of the heating sections 41 are arranged parallel to the voltage or current source 14.

In FIG. 6C, the heating hose 40 is shown in a perspective sectional view through the opposing connecting sections 42. It shows the length LS of the heating hose 40, the length LW of a heating resistor of a heating section 41 and the thickness D of the heating hose 40. The heating resistor RH of a heating section 41 is calculated as follows

RH=r·LW/A=r·LW/(D·LS),
where U is the voltage of the voltage source 14, r is the specific resistance of the heating section 41 and A is the cross-sectional area of the heating resistor or heating section. The electrical power P when the heating resistors RH of the heating hose 40 are connected in parallel is therefore calculated as follows:

P=2·U²/RH=2·U²·A/(r·LW)=2·U²·D·LS/(r·LW).

Thus, the heating resistance RH of the heating hose 40 decreases with the length LS of the heating hose 40 and the power P increases with the length LS of the heating hose 40. The power P related to the length LS of the heating hose 40 is therefore not limited for a given voltage U of the power source 14.

The connecting sections 42 of the heating hose 40 have been manufactured by coextrusion with the heating sections 41. To provide sufficient conductivity, the connecting sections 42 may have a higher concentration of electrically conductive filler 5 than the heating sections 41 and/or a more conductive filler than the filler 5 of the heating sections 41. Wires and/or metal mesh may also be introduced into the connecting sections 42. Metallic tapes can also be introduced into the thermoplastic material of the connecting sections 42, whereby the metallic tapes, wires and/or wire mesh can also be applied to the coextruded regions of the connecting sections 42. The conductivity can also be provided by a conductive coating, in particular a conductive lacquering, of the coextruded areas of the connecting sections 42.

List of reference symbols

| | |
|---|---|
| 1 | Heating hose |
| 2 | Extruder |
| 3 | Extrudate |
| 4 | Plastic |
| 5 | Filler |
| 6 | Nozzle |
| 7 | Raw hose |
| 8 | Heating section |
| 9 | Irradiation device |
| 10 | Heat source |
| 11 | Cooling unit |
| 12 | Contact |
| 13 | Pipeline |
| 14 | Voltage or current source |
| 20 | Heating hose |
| 21 | Heating section |
| 22 | Contact |
| 23 | Heating hose |
| 24 | Heating section |
| 25 | Non-heating sections |
| 26 | Clamp |
| 27 | Contact |
| 30 | Heating hose |
| 31 | Heating section |
| 32 | Non-heating section |
| 33 | Heating hose |
| 34 | Inner layer |
| 35 | Middle layer |
| 36 | Outer layer |
| 37 | Non-heating section |
| 38 | Heating section |
| 40 | Heating hose |
| 41 | Heating section |
| 42 | Connecting section |
| 43 | Contact |
| d | Tube diameter |
| D | Diameter of heating hose |
| R | Pipe diameter |

1. A heating hose for electrically heating a pipeline, a container and/or a molded part from the outside, having at least one electrically conductive heating section in the form of a heating resistor for heating the heating hose at least in sections,
wherein
the heating hose is configured as a shrink hose with a diameter (D) which is shrinkable at least in sections by heating, for shrinking onto the pipeline, the container and/or the molded part, and in that the at least one heating section has at least one thermoplastic material and at least one electrically conductive filler finely distributed in a matrix of the at least one thermoplastic material, and that the at least one electrically conductive heating section is configured for application to an electrical heating voltage or an electrical heating current for shrinking the diameter (D) at least in sections as a result of heating the at least one heating section and/or for inductively heating the at least one heating section by an alternating magnetic field and for shrinking the diameter (D) at least in sections as a result of the inductive heating of the at least one heating section.

2. The heating hose according to claim 1,
the at least one electrically conductive filler is carbon-based, in particular carbon black and/or graphite, and/or is formed by metallic particles, preferably iron and/or copper particles, and/or that the at least one thermoplastic material is a polyolefin in particular polyethylene (PE) or polypropylene (PP), polyamide (PA), fluoroethylene propylene (FEP), polyethylene terephthalate (PET), polyvinylidene fluoride (PVDF), Viton, polyvinyl chloride (PVC) and/or polytetrafluoroethylene (PTFE).

3. The heating hose according to claim 1,
wherein
the heating hose is manufactured at least in sections from a raw hose formed by extrusion and/or that the heating hose is manufactured at least in sections by widening the diameter (d) of a raw hose for drawing onto the pipeline, the container and/or the molded part.

4. The heating hose according to claim 3,
wherein
molecules of the at least one thermoplastic material are crosslinked with one another, in particular before the diameter (d) is widened, and that, preferably, the crosslinking of the molecules of the at least one thermoplastic material is carried out by means of electron irradiation.

5. The heating hose according to claim 3,
wherein
the diameter (d) of the raw hose is widened by stretching.

6. The heating hose according to claim 1,
wherein
the heating hose has a plurality of at least substantially concentric layers and that an inner layer and/or outer layer, with respect to the at least one heating section, is configured to be electrically insulating with respect to the at least one heating section.

7. The heating hose according to claim 1,
wherein
the heating hose has contacts assigned to its two opposite ends for applying the heating voltage or the heating current and that, preferably, the at least one heating section is provided circumferentially and/or over at least substantially the entire longitudinal extent of the heating hose.

8. The heating hose according to claim 1,
wherein
the heating hose has at least two heating sections which are electrically separated from one another on the circumferential side at least over approximately the entire longitudinal extent and that, preferably, the heating hose has, in particular associated with one longitudinal end, at least two contacts for applying the heating voltage or the heating current and/or one contact is associated with each heating section.

9. The heating hose according to claim 8,
wherein
the at least two heating sections are associated with a longitudinal end, preferably connected to one another with a circumferential clamp which is electrically conductive at least in sections, or that the at least two heating sections are electrically connected to one another in parallel by means of at least two electrically conductive connecting sections which extend at least substantially over the entire longitudinal extent of the heating hose.

10. The heating hose according to claim 9,
wherein
the specific resistances of the at least two heating sections are each at least twice as large, preferably at least five times as large, in particular at least ten times as large, as the specific resistances of the at least two connecting sections and/or that the at least two connecting sections are coextruded with the at least two heating sections, have at least one wire, tape and/or wire mesh and/or are formed by a conductive coating, in particular lacquering.

11. The heating hose according to
wherein
the at least one heating section is provided on the circumferential side over a length of less than 70%, preferably less than 50%, in particular less than 30%, of the circumference.

12. A method of manufacturing a heating hose, preferably according to claim 1,
in which a raw hose is extruded with at least one heating section comprising at least one thermoplastic and at least one conductive filler finely distributed in the matrix of the thermoplastic,
in which the diameter (d) of the extruded tube is widened, preferably by stretching, and
in which, preferably, the at least one heating section is connected to two electrical contacts for applying an electrical voltage or an electrical current.

13. The method according to claim 12,
in which the raw tube is coextruded from at least two different extrudates, and
in which at least one extrudate has no electrically conductive filler and
in which an electrically non-conductive non-heating section extending in the longitudinal direction and/or an inner and/or outer circumferential electrically non-conductive non-heating section is coextruded with the at least one extrudate which does not have an electrically conductive filler.

14. The method according to claim 13,
in which at least two heating sections extending in the longitudinal direction are coextruded from at least one extrudate with at least one electrically conductive filler, and
in which, preferably, the at least two heating sections are electrically conductively connected on the circumferential side, in particular with a circumferential clamp.

15. The method according to claim 12,
in which the raw tube is irradiated with electrons after extrusion and before widening in such a way that molecules of the thermoplastic are crosslinked with one another and/or
in which the raw hose is heated before expansion and cooled after expansion.

16. A method for shrinking a heating hose, preferably according to claim 1,
in which the heating hose is slipped onto a pipe, a container and/or a molded part,
in which at least two contacts of at least one heating section of the wound-up heating hose are connected to a heating voltage or a heating current and the heating voltage or the heating current heats the at least one heating section in the form of a heating resistor and/or the at least one heating section is heated inductively via an alternating magnetic field, and
in which the heating hose is shrunk onto the pipeline, the container and/or the molded part as a result of the heating of the at least one heating section while reducing the diameter (D).
